(19) United States
(12) Patent Application Publication
(10) Pub. No.: US 2011/0075277 A1
(43) Pub. Date: Mar. 31, 2011

(54) CAMERA MODULE

(75) Inventors: CHAI-WEI LEE, Tu-Cheng (TW); HOU-YAO LIN, Tu-Cheng (TW); SHENG-JUNG YU, Tu-Cheng (TW)

(73) Assignee: HON HAI PRECISION INDUSTRY CO., LTD., Tu-Cheng (TW)

(21) Appl. No.: 12/764,966

(22) Filed: Apr. 22, 2010

(30) Foreign Application Priority Data
Sep. 29, 2009 (CN) 200910307941.9

(51) Int. Cl. G02B 7/02

(52) U.S. Cl. 359/819

(57) ABSTRACT

An exemplary camera module includes a barrel and a holder. The barrel includes a first threaded part and a first cylindrical part connected to the first threaded part in an order from an object side to an image side. The first threaded part includes a plurality of external threads. The holder includes a second threaded part and a second cylindrical part connected to the second threaded part in an order from the object side to the image side. The second threaded part includes a plurality of internal threads. The barrel is coupled to the holder via the internal threads and the external threads. The inner cylindrical surface of the second cylindrical part is in contact with the outer cylindrical surface of the first cylindrical part.

### BACKGROUND

1. Technical Field

The present disclosure relates to optical imaging, and particularly to a camera module.

2. Description of Related Art

A typical camera module includes a holder and a barrel. In assembly, the barrel is screwed to the holder. Friction between internal threads of the holder and external threads of the barrel may produce some particles, in assembly. The particles may fall into optical elements (e.g., lenses, an infrared-cut filter) in the barrel, thus deteriorating imaging quality of the camera module.

Therefore, a new camera module is desired to overcome the above-mentioned problem.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is an exploded perspective view of a camera module according to an exemplary embodiment.

FIG. 2 is a cross-sectional view of the assembled camera module of FIG. 1.

### DETAILED DESCRIPTION

An embodiment will now be described in detail below with reference to the drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

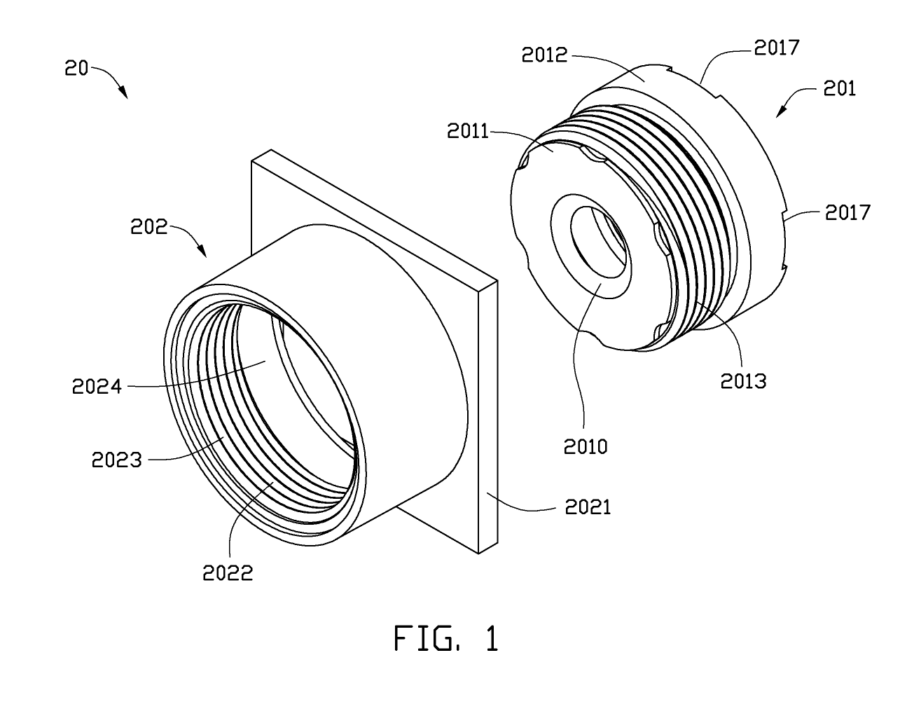

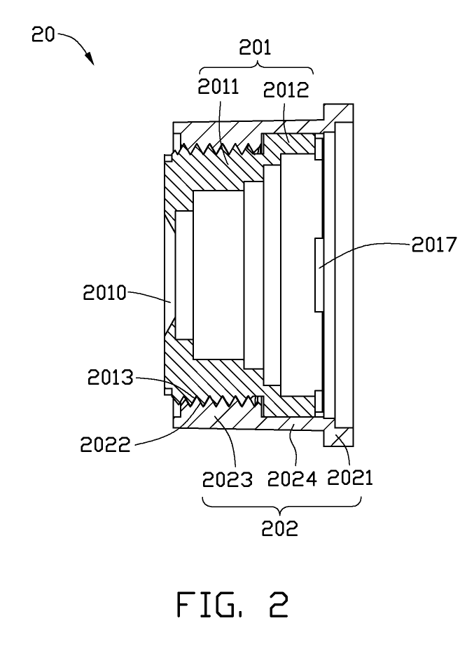

Referring to FIGS. 1-2, a camera module 20 according to an exemplary embodiment is shown. The camera module 20 includes a barrel 201, a holder 202, and a plurality of optical elements (e.g., lenses; not shown) received in the barrel 201.

The barrel 201 includes a first threaded part 2011 and a first cylindrical part 2012 in that order from the object side to the image side. The first threaded part 2011 has an opening 2010 defined in one end and a plurality of external threads 2013 formed on the outer cylindrical surface. The opening 2010 allows light incident into the barrel 201. An outer diameter of the first threaded part 2011 is less than that of the first cylindrical part 2012. It is noteworthy that in other embodiments, the outer diameter of the first threaded part 2011 is equal to that of the first cylindrical part 2012.

The barrel 201 further includes a plurality of recesses 2017 defined in one end surface facing the image side. In assembly of the camera module 20, the barrel 201 can be held in place by a tool (not shown), such as a clamp used on the recesses 2017.

The holder 202 is hollow and includes a through hole. The barrel 201 is received in the through hole. The holder 202 includes a second threaded part 2023, a second cylindrical part 2024, and a base 2021 from the object side to the image side. The complete outer cylindrical surface of the first cylindrical part 2012 is in contact with the inner cylindrical surface of the second cylindrical part 2024. The second threaded part 2023 includes a plurality of internal threads 2022. The barrel 201 engages with the holder 202 via the external threads 2013 and the internal threads 2022. An inner diameter of the second cylindrical part 2024 is larger than an outer diameter of the second threaded part 2023. The outer cylindrical surface of the first cylindrical part and the inner cylindrical surface of the second cylindrical part are both smooth surfaces.

In assembly, the barrel 201 is inserted into the through hole of the holder 202 in a direction pointing from the second cylindrical part 2024 to the second threaded part 2023, and then is screwed into the holder 202. Because the inner cylindrical surface of the second cylindrical part 2024 is in full contact with the outer cylindrical surface of the first cylindrical part 2012, most of small particles produced in screwing are sealed in a gap (not labeled) between the barrel 201 and the holder 202, and prevented from polluting optical elements in the barrel 201.

While certain embodiment have been described and exemplified above, various other embodiment from the foregoing disclosure will be apparent to those skilled in the art. The present disclosure is not limited to the particular embodiment described and exemplified but is capable of considerable variation and modification without departure from the scope and spirit of the appended claims.

What is claimed is:

1. A camera module comprising:
a barrel comprising a first threaded part and a first cylindrical part connected to the first threaded part in an order from an object side to an image side, the first threaded part comprising a plurality of external threads; and
a holder comprising a second threaded part and a second cylindrical part connected to the second threaded part in an order from the object side to the image side, the second threaded part comprising a plurality of internal threads, the barrel being coupled to the holder through threaded engagement between the internal threads and the external threads, wherein the inner cylindrical surface of the second cylindrical part is in contact with the outer cylindrical surface of the first cylindrical part.

2. The camera module of claim 1, wherein an outer diameter of the first threaded part is less than or equal to that of the first cylindrical part, and an outer diameter of the second threaded part is less than an inner diameter of the second cylindrical part.

3. The camera module of claim 1, wherein the whole outer cylindrical surface of the first cylindrical part is in contact with the inner cylindrical surface of the second cylindrical part.

4. The camera module of claim 1, wherein the first cylindrical part comprises a plurality of recesses defined in one end surface facing the image side.

5. The camera module of claim 1, wherein the outer cylindrical surface of the first cylindrical part is a smooth surface.

6. The camera module of claim 1, wherein the inner cylindrical surface of the second cylindrical part is a smooth surface.
